(19) United States
(12) Patent Application Publication
(10) Pub. No.: US 2010/0057511 A1
(43) Pub. Date: Mar. 4, 2010

(54) INTEGRATED AUTONOMOUS FLEET MANAGEMENT USING SELF-AWARE VEHICLES

(76) Inventors: Ali R. Mansouri, Bothell, WA (US); John L. Vian, Renton, WA (US); John T. Peters, Edmonds, WA (US)

Correspondence Address: HARNESS DICKEY & PIERCE, PLC, P.O. BOX 828, BLOOMFIELD HILLS, MI, 48303, US

(21) Appl. No.: 12/396,172

(22) Filed: Mar. 2, 2009

Related U.S. Application Data
(63) Continuation-in-part of application No. 12/199,435, filed on Aug. 27, 2008.

(51) Int. Cl. G06Q 10/00; G06F 7/00

(52) U.S. Cl. 705/7; 701/29

(57) ABSTRACT

An apparatus for managing a fleet of vehicles. On each of the vehicles are a plurality of vehicle subsystems, each subsystem capable of monitoring conditions and assessing capabilities of the subsystem. For each vehicle, a vehicle management system has one or more processors and memory configured to: monitor conditions and assess capabilities of the vehicle based on subsystem condition and capability information provided by the subsystems, and based on the monitored vehicle conditions and assessed vehicle capabilities, initiate performance of one or more fleet management functions.

### CROSS-REFERENCE TO RELATED APPLICATIONS

This application is a continuation-in-part of U.S. patent application Ser. No. 12/199,435 filed on Aug. 27, 2008. The disclosure of the above application is incorporated herein by reference in its entirety.

### FIELD

The present disclosure relates generally to vehicle fleet management and more particularly (but not exclusively) to providing management of a fleet of self-aware vehicles.

### BACKGROUND

The statements in this section merely provide background information related to the present disclosure and do not necessarily constitute prior art.

Maintaining a fleet of aircraft can be costly and time consuming for an airline, even with the aid of diagnostic data currently provided by some aircraft systems. Each individual aircraft may provide fault data and/or reports for a number of its systems and/or subsystems. This information is typically analyzed on the ground by a third party, who may assess conditions of reported systems/subsystems and provide a diagnosis to the airline. Typically the airline processes the diagnoses provided by the third party for each airplane individually to manually assess the condition of each airplane. When these individual assessments are completed, the airline may or may not to be able to use them in planning scheduled service events as part of its fleet management.

### SUMMARY

The present disclosure, in one implementation, is directed to an apparatus for managing a fleet of vehicles. On each of the vehicles are a plurality of vehicle subsystems. Each subsystem is capable of monitoring conditions and assessing capabilities of the subsystem. For each vehicle, a vehicle management system has one or more processors and memory configured to: monitor conditions and assess capabilities of the vehicle based on subsystem condition and capability information provided by the subsystems, and based on the monitored vehicle conditions and assessed vehicle capabilities, initiate performance of one or more fleet management functions.

In another implementation, the disclosure is directed to a automated method of managing a fleet of vehicles. In each vehicle, each of a plurality of subsystems of the vehicle monitors its subsystem condition and assesses its subsystem capabilities based on the monitored subsystem condition. A vehicle management system for each vehicle monitors conditions of the vehicle based on condition information from the subsystems and assesses capabilities of the vehicle based on the subsystem conditions and capabilities. Based on the vehicle condition and capabilities, the vehicle management system for a given one or more of the vehicles performs one or more fleet management functions cooperatively with a fleet management system.

In yet another implementation, the disclosure is directed to a self-aware vehicle that includes a plurality of vehicle subsystems. Each subsystem is capable of monitoring conditions and assessing capabilities of the subsystem. A vehicle management system has one or more processors and memory configured to monitor conditions and assess capabilities of the vehicle based on subsystem condition and capability information provided by the subsystems, and based on the monitored vehicle conditions and assessed vehicle capabilities, initiate performance of one or more fleet management functions.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

The drawings described herein are for illustration purposes only and are not intended to limit the scope of the present disclosure in any way.

FIG. 1 is a diagram of a transponder module in accordance with one implementation of the disclosure;

FIG. 2 is a diagram of models used by transponder module processor(s) in a method of determining aircraft conditions and capabilities in accordance with one implementation of the disclosure;

FIG. 3 is a diagram of a vehicle in which transponder module information is used in accordance with one implementation of the disclosure;

FIGS. 4 and 5 are diagrams illustrating use of transponder module information off-board a vehicle in accordance with one implementation of the disclosure;

FIG. 6 is a diagram illustrating use of transponder module information to support autonomous operations of a plurality of vehicles in accordance with one implementation of the disclosure;

FIG. 7A is a diagram illustrating distribution of transponder module functions between a vehicle and a system off-board the vehicle in accordance with one implementation of the disclosure;

FIG. 7B is a diagram illustrating distribution of transponder module functions between subsystems of a vehicle in accordance with one implementation of the disclosure;

FIG. 8 is a diagram of a mission control hierarchy that uses transponder information in a planning function that assigns tasks and issues commands to vehicles in accordance with one implementation of the disclosure;

FIG. 9 is a diagram illustrating transponder information for a plurality of vehicles in a matrix useful in optimization of tasking and control of vehicles in accordance with one implementation of the disclosure;

FIG. 10 is a block diagram of an apparatus for managing a fleet of vehicles in accordance with one implementation of the disclosure;

FIGS. 11A and 11B are a functional diagram of vehicle fleet management in accordance with one implementation of the disclosure; and

FIGS. 12-15 are diagrams of apparatus for vehicle fleet management in accordance with various implementations of the disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The term “transponder” is used in the disclosure and the claims to refer to an apparatus, system, module or device that may provide information substantially continuously, periodically, and/or occasionally. Although a “transponder” in accordance with various implementations may provide information in response to a poll, query or other request, it may additionally or alternatively provide information in the absence of a poll, query or other request.

The term “transponder” is used in the disclosure and the claims to refer to an apparatus, system, module or device that may provide information substantially continuously, periodically, and/or occasionally. Although a “transponder” in accordance with various implementations may provide information in response to a poll, query or other request, it may additionally or alternatively provide information in the absence of a poll, query or other request.

The present disclosure, in various implementations, is directed to a transponder module and system configured to determine and communicate vehicle conditions and capabilities. Configurations of the transponder module and system can be implemented in relation to substantially all types of vehicles in which sensor information is provided, including but not limited to air, land, space, and/or water vehicles. In various implementations, changing vehicle conditions and capabilities are determined in real-time. Information as to the determined vehicle conditions and/or capabilities may be provided to a control system on board the subject vehicle and/or to one or more off-board systems, e.g., to system(s) used by mission planners to plan and/or execute a mission that includes use of the vehicle.

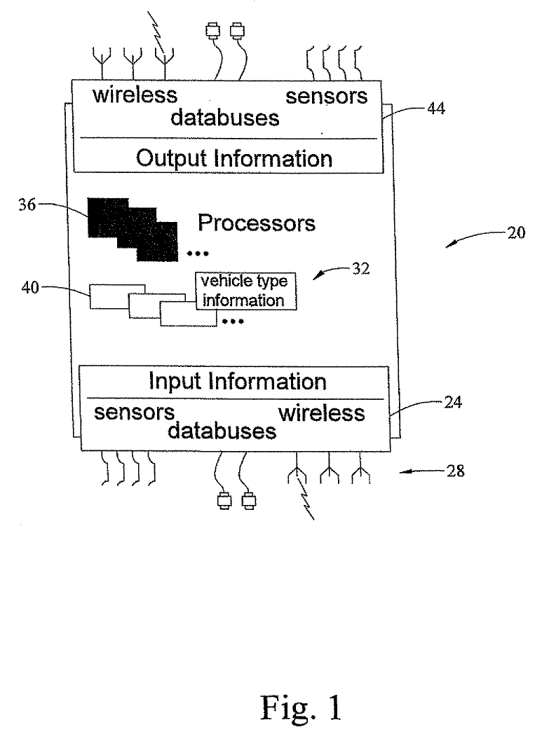

In various configurations, sensors of a vehicle may be connected with a transponder module to form a system for determining and communicating vehicle condition and capabilities. One configuration of a transponder module is indicated generally in FIG. 1 by reference number 20. The module 20 includes a vehicle sensor input interface 24 having a plurality of wired and wireless sensor interfaces indicated generally as 28. The input interface 24 is capable of receiving sensor input from a plurality of different types of vehicle sensors and from a plurality of different types of vehicles. In some configurations the input interface 24 is substantially universal. The interface 24 is capable of communicating, for example, via discrete, analog, wired and/or wireless signals and/or via data bus. In various configurations, the module 20 is designed to be installed on substantially any type of vehicle. It should be noted, however, that implementations are contemplated in which an input interface may be specifically configured for a particular vehicle type.

The module 20 includes a computing system 32 having one or more processors 36 and memory 40. Some of the memory 40 is static memory for storage of, e.g., information corresponding to a vehicle in which the module 20 is to be configured. When the module 20 is configured in a given vehicle, a vehicle type and vehicle systems information for the given vehicle are stored in the memory 40. When, e.g., the given vehicle is in operation, the processor(s) 36 and memory 40 receive vehicle sensor input data via the input interface 24 in real time. The processor(s) 36 use, e.g., the sensor input data, vehicle type and vehicle system information to determine conditions, in real time, of a plurality of subsystems of the given vehicle. Based on the determined conditions, the processor(s) 36 determine realtime and/or future performance capabilities of the given vehicle. The term “real time” is used to mean essentially instantaneous.

The computing system 32 also includes, e.g., dynamic memory, software programs for processing input data to compute conditions of vehicle subsystems and components, and software programs that process input data and computed vehicle condition information to compute capabilities of a vehicle. The processor(s) 36 may use software agents and may execute decision tables, neural networks, physical models, and perform other computational functions in determining vehicle conditions and/or capabilities as further described below.

The module 20 also includes an output interface 44 for outputting information via wired or wireless communication devices, for example, to one or more systems or subsystems that may or may not be onboard a vehicle. In various implementations the output communication interface 44 is modular and supports various combinations of commonly used optical, wired, and/or wireless methods. Such methods include, e.g., optical and wire point-to-point and/or multiplexed communication systems and protocols, and bluetooth, WiFi, WiMAX, cellular, satellite, and other wireless communication methods. Output information that may be determined and communicated by the module includes 1) vehicle type information, 2) vehicle condition information, and/or 3) vehicle capabilities information. The module 20 communicates component conditions and vehicle capabilities to other systems, e.g., to enable maintenance planning, mission planning, or any combination thereof. In some implementations, various functions performed in determining vehicle conditions and capabilities may be performed off-board a vehicle, e.g., by processors of an off-vehicle management system.

The module 20 may be electrically powered in various ways, e.g., by a vehicle in which the module 20 is included. Additionally or alternatively, power may be provided via a self-contained component, using any of a plurality of combinations of energy storage and/or energy harvesting devices. In some implementations, to install the module 20 in a vehicle, a “personality” module providing at least (a) a type of the vehicle and (b) information describing a suite of sensors associated with the vehicle type is loaded to static memory 40 of the module 20. The input and output interfaces 24 and 44 are connected respectively with appropriate input sensors and output devices in the vehicle. In some configurations, the module 20 is included in a single line-replaceable unit (LRU) of the vehicle.

Examples of vehicle types relative to which the module 20 may be installed include, without limitation, fixed-wing flight vehicles, rotorcraft flight vehicles, wheeled land vehicles, tracked land vehicles, hovercraft land vehicles, surface watercraft, underwater watercraft, reusable spacecraft, expendable spacecraft, orbiter spacecraft, rover spacecraft, and other or additional categories and classes of vehicles.

In various implementations, the processor(s) 36 use vehicle sensor input information to determine current and/or predicted future conditions of vehicle components. Conditions of vehicle components can vary dependent on, e.g., component age, operating environment, and/or actual component usage. Vehicle component condition information determined by the processor(s) 36 can include but is not necessarily limited to the following: battery remaining useful life in terms of time, battery remaining useful life in terms of mission task cycles, fuel quantity, vehicle weight, structure health in terms of number of remaining cycles, structure health in terms of maximum load capacity, structure health in terms of thermal limits, remaining useful life of various subsystem components in terms of time, remaining useful life of various subsystem components in terms of cycles, component failures, changes in aerodynamic performance parameters, changes in energy usage rate, and other parameter measurements and computed predictions that provide indication of system conditions.

Vehicle component conditions may be determined, for example, using model-based and/or non-model-based algorithms, including but not limited to those commonly used in the practice of prognostic vehicle health management. Such algorithms may use, e.g., design reliability data, usage history, actual measured component operating parameters, planned future use, etc., individually and/or in combination(s). Algorithms may be implemented using traditional and/or agent-based software programming methods that allow serial and/or parallel processing. Standard database schemas and information models may be used in implementations of the transponder module 20. In such manner, e.g., software libraries may be used, software libraries may be loaded to hardware, and appropriate connections to external inputs and outputs may be established.

Current and predicted future conditions of vehicle components can be determined and provided, for example, to optimize the planning of maintenance of the vehicle. Vehicle capabilities may be determined by the processor(s) 36 using, e.g., vehicle design specifications, installed subsystem configuration information, vehicle operating conditions, vehicle and subsystems state, component conditions, etc., individually and/or in combination(s). Various model-based and/or non-model-based algorithms and methods, including but not limited to those commonly used in the practice of engineering, may be used to determine vehicle capability information. Such algorithms and methods may be implemented using traditional and/or agent-based software programming methods that allow sequential and/or parallel processing.

Vehicle capability information can include but is not necessarily limited to the following: maximum acceleration, maximum braking (deceleration) rate, maximum speed, minimum speed, minimum turn radius, maximum range, maximum endurance, mission on-board sensors type (e.g., types available under current conditions), mission off-board sensors type (e.g., types available under current conditions), mission sensors performance, maximum payload weight, payload type, communications system type (e.g., types available under current conditions), maximum climb rate, and other or additional static and dynamic vehicle performance metrics and/or limits.

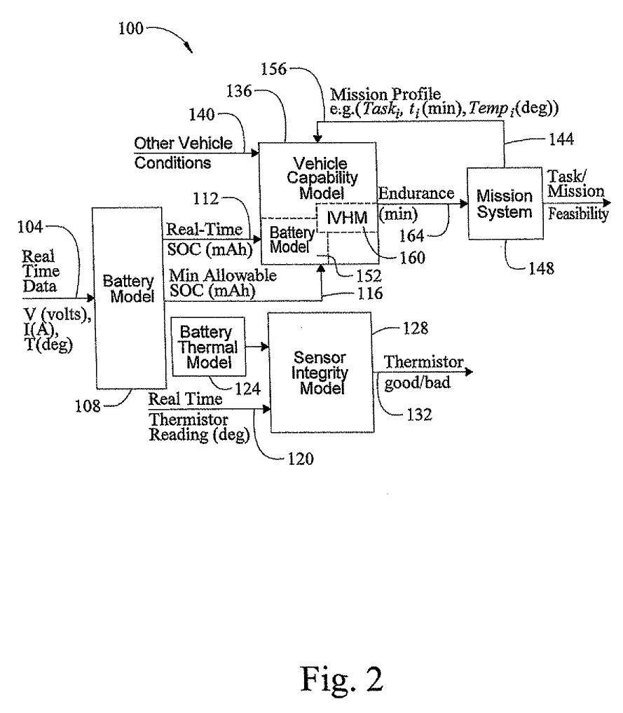

In one exemplary implementation, a transponder module determines conditions of components and subsystems of an aircraft. The determined conditions may be used in determining capabilities of the aircraft, for example, as shall now be discussed with reference to FIG. 2. A diagram of models used by transponder module processor(s) in implementing a method of determining aircraft conditions and capabilities is indicated generally in FIG. 2 by reference number 100. For purposes of providing an example, modeling of a battery of the aircraft is shown in and discussed herein with reference to FIG. 2. Although other components and subsystems of the aircraft are not discussed in detail, it should be understood that the same or similar methods as those discussed with reference to the battery may be applied in relation to other components and/or subsystems of the aircraft.

In the present example, the aircraft battery is monitored to provide real-time battery diagnostics and prognostics. Real-time sensor data received via the input interface 24 (shown in FIG. 1) includes battery voltage, battery current, and battery temperature, indicated collectively in FIG. 2 by reference number 104. The sensor data 104 are input to a battery model 108, which is implemented to determine a real-time state-of-charge (SOC) 112, e.g., in milliamp hours (mAh) and a minimum allowable state-of-charge (SOC) 116, e.g., in milliamp hours (mAh). It should be noted that although various units of measurement are mentioned in the disclosure and shown in the Figures, the disclosure is not so limited.

Sensor data received via the input interface 24 also includes a reading 120 from a thermistor that measures battery temperature. The thermistor input 120 and a battery thermal model 124 are used in a sensor integrity model 128, which is implemented to determine whether the thermistor from which the reading 120 was obtained is operating properly. Implementing the sensor integrity model 128 results in an output 132 indicating the thermistor condition, e.g., whether the thermistor is good or bad. The diagnostic output 132 may be used in other or additional modeling and/or algorithmic calculations and may be input as one of a plurality of vehicle conditions to a vehicle capability model 136.

The vehicle capability model 136 is used to model relationship(s) between aircraft conditions and dynamic and payload capabilities of the aircraft. Thus the capability model 136 is implemented using information as to aircraft conditions. Condition-related information used in the capability model 136 includes, without limitation, condition data 140 for other subsystems of the aircraft, as well as the state-of-charge condition data 112 and 116 for the battery. The condition data 140 for other subsystems and components may be determined in various ways, including but not limited to model-based methods as previously discussed.

The capability model 136 may receive input 144 from a mission system model 148 that describes, e.g., a mission profile. A mission profile may include tasks and their duration, e.g., take-off, land, waypoint flight, running a sensor, running a communication link for a certain duration. The mission profile may also include environmental parameters, e.g., an ambient temperature profile. A profile might specify, for example, that the aircraft is to fly in freezing temperatures for a certain duration, and then in a milder environment for a certain duration.

Included in the capability model 136 is a model 152 for modeling capabilities of the battery in relation to overall vehicle capabilities. Data used in the capability model 136 includes, among other things, current and/or power consumption and minimum operating voltage of various sensors of the aircraft. The sensor inputs can be used in the capability model 136, for example, to determine a discharge profile (e.g., expressed as current versus time) for the battery based on an input mission profile 156. The capability model 136 may also include a thermal model of the battery that may be used to predict battery temperature based on a discharge profile.

The capability model 136 may be adjusted substantially continuously in accordance with real-time integrated vehicle health monitoring (IVHM) diagnostic data 160 from an IVHM system of the aircraft. Capability adjustments determined in the capability model may be provided, e.g. to the mission system model 148, in which feasibility of tasks and/or a mission may be adjusted to account for the change in capability. For example, if a motor of the aircraft is determined to be drawing increased current due to increased friction, the capability model 136 may determine endurance 164 based on the increased motor power consumption. The revised (in this case, decreased) endurance may be used in the mission system model 148 to change a feasibility evaluation for a task and/or mission.

Other subsystems of the aircraft may be modeled in ways similar to those described above for the battery to provide the condition data 140 for the other subsystems to the capability model 136. It should be noted generally that vehicle subsystem behavior and conditions, as well as relationships among vehicle conditions and vehicle capabilities, may be determined in various ways including, in addition to, or instead of modeling as shown above.

Referring again to FIG. 1, the module 20 may output information as to vehicle conditions and capabilities via the wired and/or wireless output interface 44 to one or more systems or subsystems, including but not limited to subsystem(s) of the vehicle itself. Output parameters can, e.g., be defined by a user or selected from a predefined list. Features of output parameters such as engineering units, update rate, and/or other information describing the parameter information may be included with the parameter definition. Output parameter features are communicated along with actual parameter values, e.g., to user(s) of the information. Examples of output parameter features include: “‘Minimum turn radius at current time’ units=feet, update rate=1 second” and “‘Minimum turn radius 10 minutes from current time’, units=feet, update rate=1 minute”.

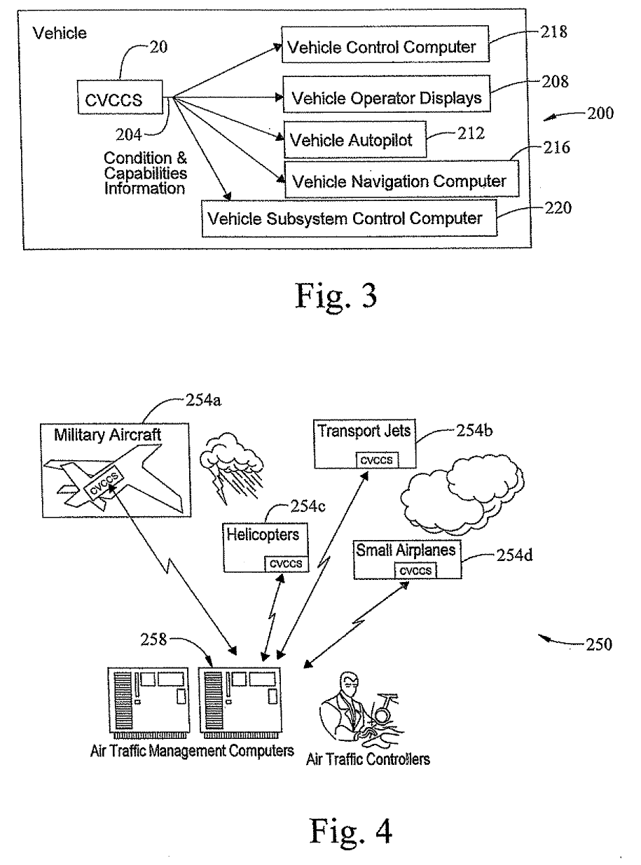

Information from a transponder module 20 may be used onboard and/or off-board a vehicle that includes the module. A diagram of a vehicle in which transponder module information is used is indicated generally in FIG. 3 by reference number 200. Condition and capability information 204 from the module 20 (occasionally referred to in the disclosure as “Common Vehicle Condition and Capabilities System”, or “CVCCS”) is output, e.g., to operator displays 208, an autopilot 212, a navigation computer 216, a vehicle control computer 218, and/or a vehicle subsystem control computer 220 of the vehicle.

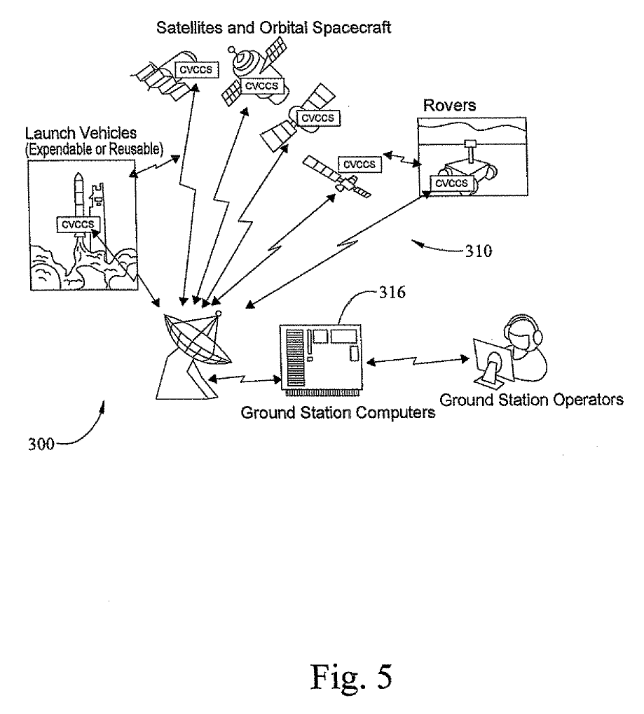

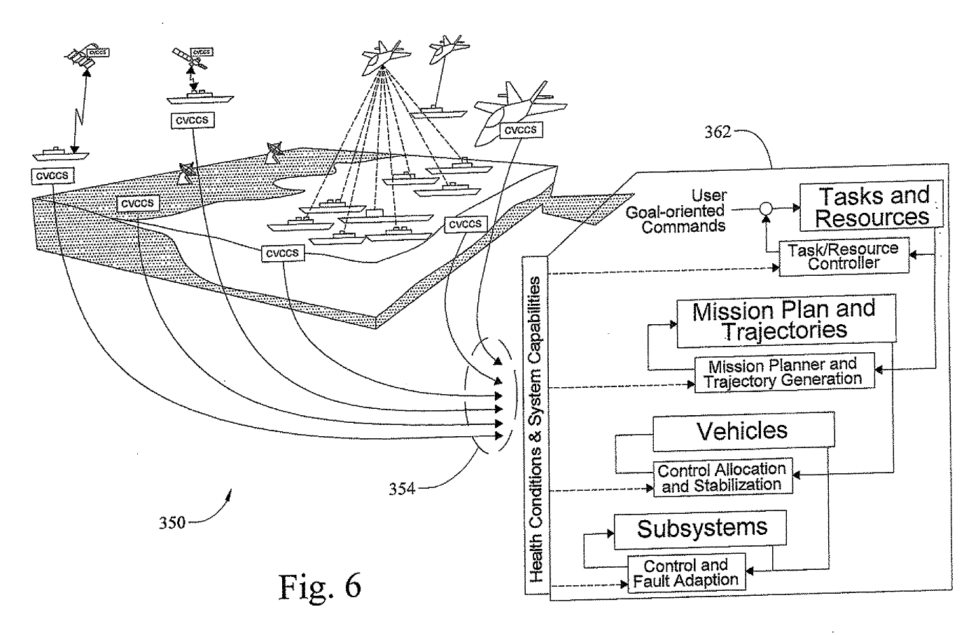

A diagram illustrating use of transponder module information off-board a vehicle is indicated generally in FIG. 4 by reference number 250. Aircraft 254a-254d transmit transponder module information to computers 258 for use, e.g., by air traffic controllers. It should be noted that the aircraft 254a-254d are of different types, i.e., military aircraft 254a, transport jets 254b, helicopters 254c, and small airplanes 254d. Another use of transponder module information off-board a vehicle is indicated generally in FIG. 5 by reference number 300. Launch vehicles, satellites, orbital spacecraft, and space rovers collectively numbered 310 transmit transponder module information to ground station computers 316 for use by ground station operators.

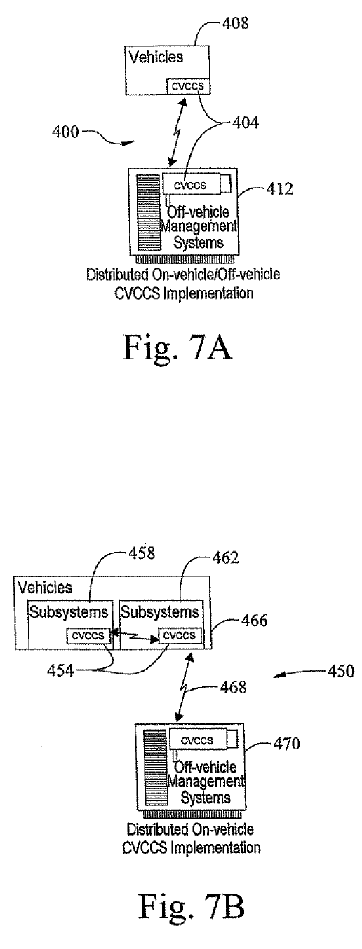

A diagram illustrating use of transponder module information to support autonomous operations of a plurality of vehicles is indicated generally in FIG. 6 by reference number 350. Information 354 as to conditions and capabilities of aircraft, watercraft and other vehicles collectively numbered as 358 is transmitted to a mission planning system 362. Vehicle condition and capabilities information may be used, e.g., in assigning tasks to the vehicles, mission task planning, vehicle navigation planning (e.g., in relation to time/space trajectory planning for an aerial vehicle), control adaptation in response to degraded or changed vehicle capabilities, remaining useful life contingency planning, and other or additional health-adaptive command and control functions.

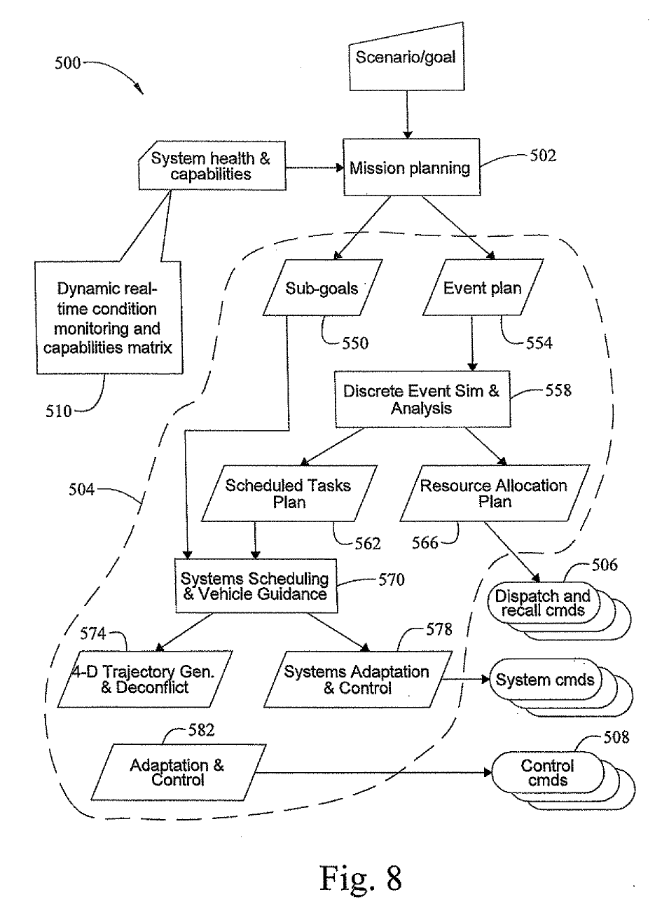

Based on the type of vehicle configured with a transponder module 20, the module itself may be completely onboard a vehicle, e.g., fully contained in a single line replaceable unit (LRU), or distributed among the vehicle, vehicle subsystems, and/or ground based systems. A diagram illustrating distribution of transponder module functions between a vehicle and a system off-board the vehicle is indicated generally in FIG. 7A by reference number 400. Various computing functions of a transponder module 404 may be distributed between a vehicle 408 and one or more management systems 412.

A diagram illustrating another distribution of transponder module functions is indicated generally in FIG. 7B by reference number 450. Various transponder module functions 454 may be distributed between subsystems 458 and 462 of a vehicle 466. Condition and capabilities information 468 is sent to one or more management systems 470. Vehicle subsystems 458 and/or 462 may include one or more actuators for use in operating the vehicle 466. In such case, operational control of the vehicle 466 may be modified in response to transponder module condition and capabilities information.

Various implementations of the disclosure provide local (i.e., on-board) condition and capability information for safety-critical decision-making and control adaptation within a vehicle control system. A mission command and control system can dynamically assign a plurality of vehicles of various types to perform specific tasks based on individual vehicle conditions and capabilities. Implementations of the disclosure provide information that enables management of vehicle operations by humans and, additionally or alternatively, autonomous mission management and task planning devices. Information provided by such a system is also useful for optimal planning of vehicle maintenance.

In some implementations, it is contemplated that air, ground, and space vehicles would be configured as modular multi-use platforms. A given vehicle, then, might be reconfigurable, e.g., as a transport vehicle, surveillance sensor platform, and/or weapons delivery vehicle. Airplanes and helicopters are contemplated as modular systems composed of fuselage/payload, engines, wings, avionics, mission systems, and sensors. Reusable launch vehicle spacecraft could also be modular systems composed of main engines, solid rocket boosters, external tank, thermal protection systems, and a variety of crew station and other payload and mission modules attached via common adapter interfaces. Orbiter spacecraft, such as satellites, may also be modular in that they are composed of a primary frame structure, engines, major subsystems consisting of power supply and distribution systems, navigation systems, onboard processing systems, thermal management systems and payload consisting of fuel, weapons system, optics, command and telemetry communication systems, and/or scientific instruments. The ability to know the capabilities of a vehicle based on its configuration can be highly valuable if not essential in mission planning and networked operation of reconfigurable multi-role platforms. In various implementations of the disclosure, the capabilities of such reconfigurable vehicles can be computed using input signals from the vehicle modular systems and vehicle type information stored in memory.

Air vehicles are also contemplated as having shape-changing (morphing) capabilities. As a vehicle morphs, its capabilities (e.g., turn radius, endurance, etc.) can change dramatically in a very short amount of time. The ability to know the capabilities of such a vehicle in real-time can be highly valuable if not essential for mission planning and autonomous operations. In various implementations of the disclosure, capabilities of such a vehicle can be computed in real-time based on its morphed state. Thus, vehicle control, mission planning, and autonomous operation can be performed in an optimal manner.

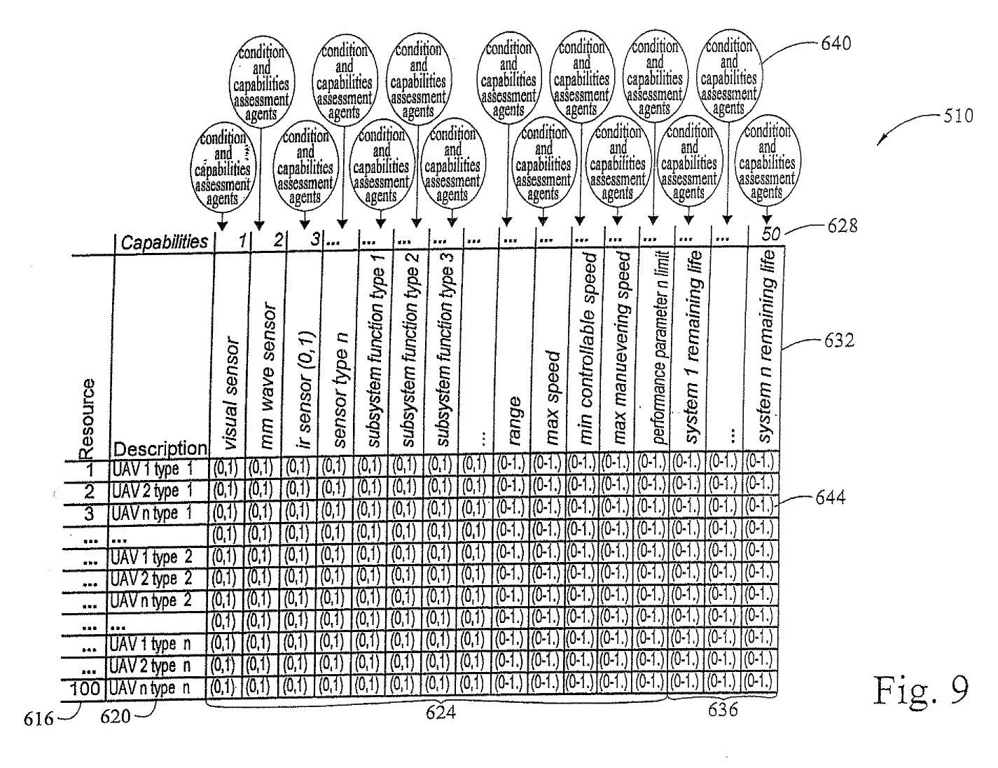

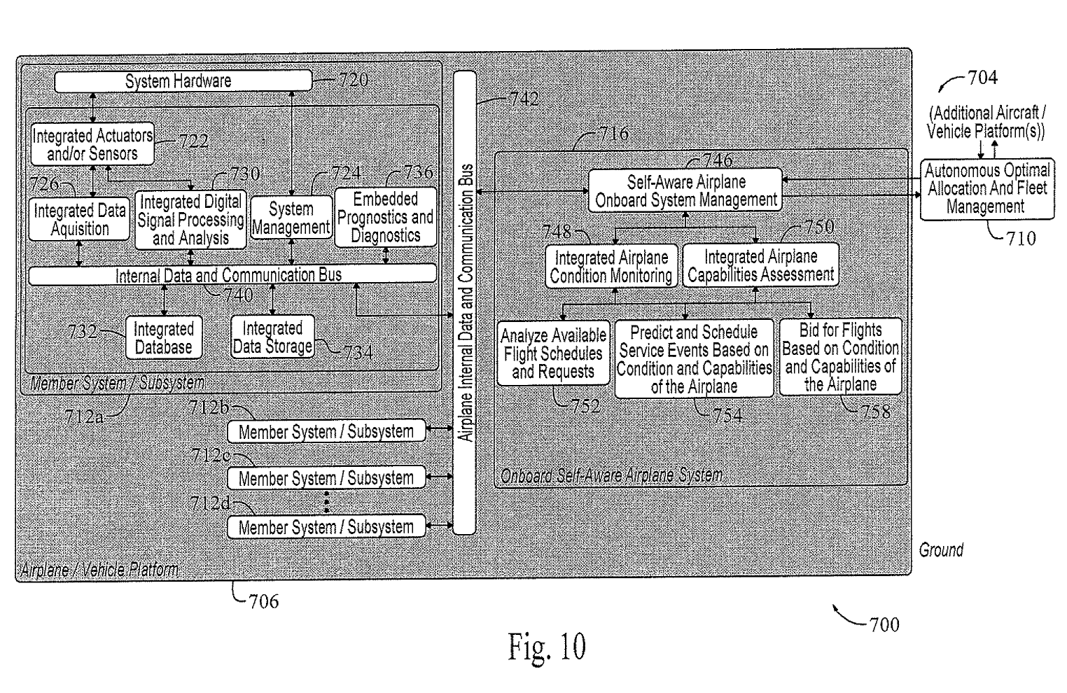

An architecture and functional elements to perform health-based mission planning, resource allocation, and task allocation is indicated generally in FIG. 8 by reference number 500. In the present implementation, a condition and capabilities matrix 510 including vehicle condition and capabilities information is used by a mission planning function 502 that communicates with a plurality of vehicles available as resources in a mission. Each vehicle is configured with a transponder module as previously described. An agent-based process of determining vehicle condition and capabilities may be used to determine the condition and capabilities information included in the matrix 510. The matrix 510 is shown in greater detail in FIG. 9.

Referring again to FIG. 8, the mission planning function 502 communicates with optimization functions indicated generally by reference number 504. Optimization functions 504 may be used in combination, e.g., to compute dispatch and recall instructions 506 to vehicles and command signals 508 to vehicle systems and controllers. Optimization functions 504 may include, but are not limited to, programs that compute sub-goals 550, event plans 554, simulation analysis 558, task plans 562, resource allocation 566, systems schedules and vehicle guidance 570, trajectories 574, systems adaptation 578, and vehicle and flight adaptation and control 582.

Referring now to FIG. 9, mission resources are vehicles, which may be of different types. Resources are identified by number in a column 616 and described in a column 620. Capabilities 624 for each vehicle are identified by number in a row 628 and described in a row 632. Conditions 636 for each vehicle also are identified by number in the row 628 and described in the row 632. Software agents 640 obtain condition and capabilities information from the transponder module of each vehicle. The information is used to update cells 644 of the matrix in real time. Thus the matrix 510 provides a mission-wide view of vehicle capabilities and conditions in real time.

Various implementations of the foregoing transponder modules and systems can be used in many different environments, including but not limited to air traffic management. An ability to provide vehicle condition, vehicle capabilities, or any combination thereof, to air traffic controllers can enhance the efficiency and safety of air transportation. Furthermore, vehicle condition and capabilities information provided by the foregoing transponder module and system can promote safe and optimal performance of air traffic management advisory systems and autonomous air traffic management systems.

Marine traffic management is another environment in which implementations of the foregoing transponder module and system configurations can be useful. The ability to provide vehicle condition, vehicle capabilities, or any combination thereof, to maritime vehicle captains, maritime traffic controllers, emergency responders, or any combination thereof, can enhance the efficiency and safety of maritime vessels.

The disclosure can also be implemented in relation to personal automobile, highway transport vehicle, and highway traffic management. The ability to provide automobile condition and capabilities, highway transport vehicle condition and capabilities, or any combination thereof, to vehicle drivers, vehicle autonomous subsystems, and highway traffic management systems can enhance the efficiency and safety of highway transportation.

Implementation is also contemplated in connection with heterogeneous teams of vehicles used, e.g., in disaster relief, search and rescue, security, and/or defense applications. The ability to provide vehicle condition and capabilities information to mission strategists, task assignment schedulers, vehicle mission and trajectory planners, vehicle control distributors, subsystem control adaptation, or any combination thereof, can enhance the probability of achieving overall mission objectives. Furthermore, the providing of vehicle condition and capability information to such adaptive systems makes it possible to calculate a theoretical probability of mission success.

### Inhabited and Uninhabited Aircraft and Spacecraft

The ability to provide aircraft condition and capabilities information to pilots or autonomous flight management systems can enhance the efficiency, safety, and mission reliability of aircraft operations. The ability to provide spacecraft condition and capabilities information to crew and/or ground station operators as well as to autonomous mission management systems can enhance the efficiency, safety, and mission reliability of spacecraft operations. In addition, condition and capabilities monitoring of reusable launch vehicles can help meet needs of quick-turnaround “aircraft-like reusable access to space.” For instance, reusable launch vehicle maintenance and asset launch scheduling may be performed based on the transponder-module-monitored capabilities of each individual vehicle to perform a given payload and orbit mission type. Also, on-orbit refueling, reconfiguring, or repair of otherwise expendable satellites could be performed by one or more refuel/repair spacecraft in an optimized manner by coordinating the repositioning of satellite constellations, each with known limited fuel supply (range) and maneuverability, to minimize the overall system cost of performing the repositioning task while ensuring that all rendezvous points are achievable, the desired refuel/repair is completed in the allotted time, and the overall satellite constellation continues to meet functional requirements.

Planning missions, assigning tasks to vehicles, and coordinating events in multi-vehicle operating environments can be optimized when knowledge of individual vehicle component conditions and vehicle capabilities is made available. In various implementations of the disclosure, this information can be provided from a variety of vehicles and vehicle types in a standard form.

Some configurations provide an apparatus for managing a fleet of vehicles. On each of the vehicles are a plurality of vehicle subsystems. Each subsystem is capable of monitoring its own conditions and assessing its own capabilities. For each vehicle, a vehicle management system is provided that includes one or more processors and memory configured to monitor conditions and assess capabilities of the vehicle based on subsystem condition and capability information provided by the subsystems. Based on the monitored vehicle conditions and assessed vehicle capabilities, the vehicle management system may initiate performance of one or more fleet management functions.

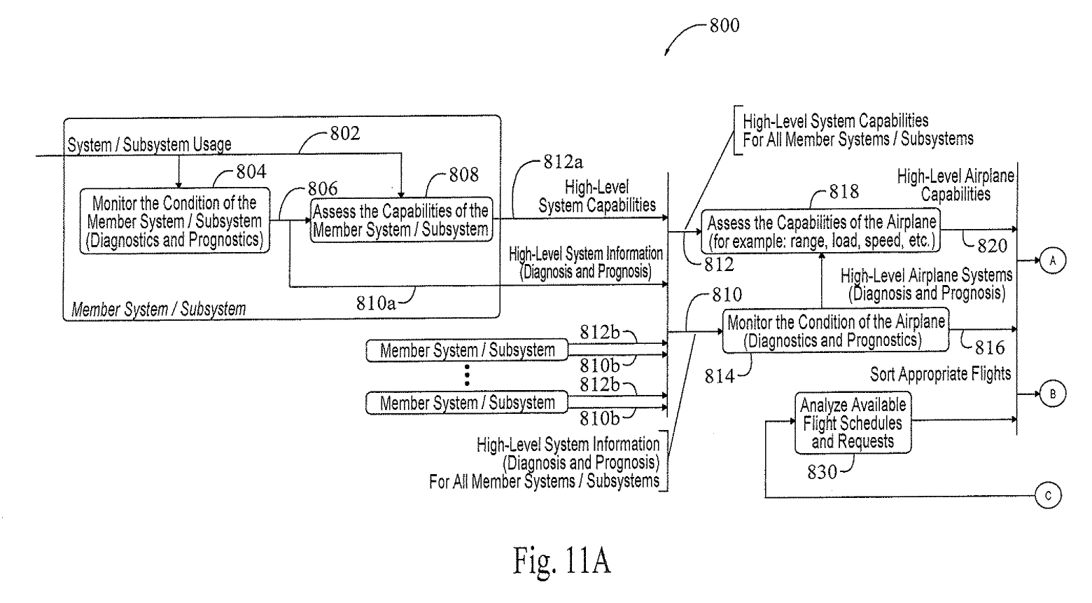

One such apparatus is indicated generally in FIG. 10 by reference number 700. A fleet 704 includes, e.g., a plurality of aircraft 706, one of which is shown in FIG. 10. Each aircraft 706 is configured to communicate with a fleet management system 716, which in the present embodiment is located on the ground. Each aircraft 706 is self-aware. That is, each aircraft 706 is capable of monitoring its own condition and assessing its own capabilities. Each aircraft 706 has a plurality of subsystems, referred to collectively by reference number 712. Four exemplary subsystems 712a-712d are shown in FIG. 10. Each subsystem 712 of the aircraft is self-aware, i.e., capable of monitoring its own condition and assessing its own capabilities. Self-awareness may be embedded or otherwise integrated into a subsystem 712.

Each aircraft 706 includes an aircraft management system 716 having one or more processors and memory. In the present implementation, the aircraft management system 716 is onboard the aircraft 706. The aircraft management system 716 of each aircraft 706 in the fleet is configured to monitor conditions and assess capabilities of the aircraft 706 based on subsystem condition and capability information provided by the aircraft subsystems 712. Based on the monitored conditions and assessed capabilities of an aircraft 706, the aircraft management system 716 of the aircraft may initiate performance of one or more fleet management functions as further described below. Thus an aircraft 706 may perform management function(s) in cooperation with the fleet management system 716 as further described below.

One configuration of a subsystem numbered as 712a in FIG. 10 includes hardware 720 for performing one or more functions of the subsystem. One or more actuators and/or sensors 722 are in communication with the hardware 720. The actuator(s) and/or sensor(s) 722 are also configured to communicate with a system management means 724 and a data acquisition means 726. Also integrated in the subsystem 712a are digital signal processing and analysis means 730, a database 732, and data storage 734. An embedded functionality 736 is provided whereby the condition of the subsystem 712a is analyzed to obtain prognostics and diagnostics as to the subsystem 712a. The foregoing subsystem components communicate via an internal data and communication bus 740 to provide condition and capability information for the subsystem 712a.

The subsystems 712 may communicate with the aircraft management system 716 via an aircraft internal data and communication bus 742. Each of the subsystems 712 provides, in substantially real time, subsystem condition information, including subsystem diagnostics and prognostics, as well as subsystem capability information to the aircraft management system 716. Additionally, the aircraft management system 716 may provide aircraft system information to one or more subsystems 712 via the bus 742. It should be noted, however, that embodiments are contemplated that do not include a bus 742. Additional or alternative communication means may be provided between one or more subsystems 712 and the aircraft management system 716 in embodiments that do not, e.g., include the data bus 742.

As previously mentioned, each subsystem 712 is “self-aware”. Many aircraft subsystems, including but not limited to power systems, engine systems and subsystems, auxiliary power units (APUs), etc., may be embedded with self-aware functionality. It should be noted that a subsystem 712 could be supplier-provided and “plug-in-ready”. For example, a commercially available battery having integrated, programmable electronics could be programmed, e.g., to provide high-level diagnostics and/or prognostics for use by the aircraft management system 716 in making a decision. Additionally or alternatively, some “plug-in” subsystems 712 may be ready to provide subsystem condition and/or capability information without additional programming. A given subsystem 712 may include other self-aware subsystems that provide lower-level subsystem condition and/or capability information to the given subsystem 712.

Integrated into the aircraft management system 716 are a self-aware aircraft system management functionality 746, means for aircraft condition monitoring 748, and means for aircraft capabilities assessment 750. In some implementations, the integrated aircraft condition monitoring means 748 and capabilities assessment means 750 include a transponder module as previously described, e.g., with reference to FIG. 1.

Also provided in the aircraft management system 716 are a capability 752 for analyzing available flight schedules and requests and a capability 754 for predicting and scheduling service events for the aircraft 706 based on condition and capabilities of the aircraft 706. A capability 758 is also provided for bidding for flights, also based on condition and capabilities of the aircraft 706. The self-aware aircraft system management functionality 746 is configured for communication with the ground-based fleet management system 710.

It should be noted generally that although various functionalities in various implementations of the disclosure may be shown in the Figures as one or more blocks and/or process(es), the disclosure is not so limited. It will be understood by those knowledgeable in the art that various functionalities may be structured in many different ways and using various components. For example, a given functionality may be provided by a single system, more than one system and/or subsystems, etc. Where, e.g., functionality is provided by, through, and/or using one or more computers, there could be one or more processors, memory of various type(s) and/or size(s), various input and/or output devices, buses, etc.

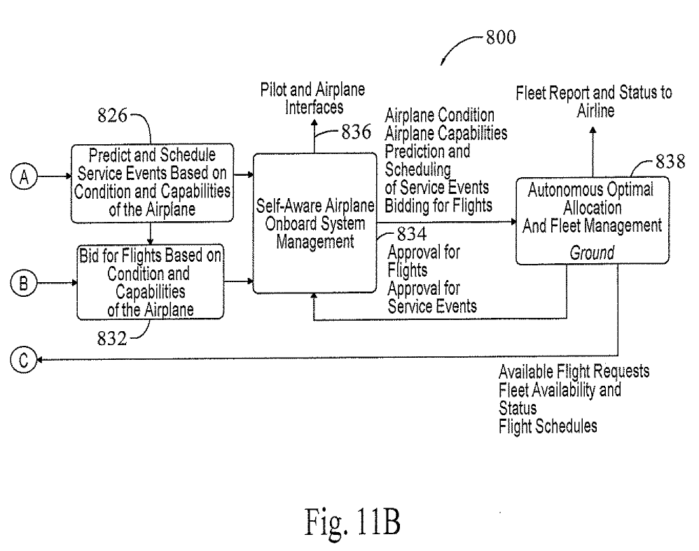

A functional diagram illustrating one implementation of autonomous management of a fleet of aircraft is indicated generally in FIGS. 11A and 11B by reference number 800. Referring, e.g., to FIG. 10, in a given aircraft 706, a given subsystem 712 receives usage information 802 and monitors its own condition in a process 804 to obtain subsystem diagnostics and prognostics 806. In a process 808 the given aircraft subsystem 712 uses the diagnostics and prognostics 806 and subsystem usage information 802 to assess its subsystem capabilities.

An aircraft subsystem 712 provides high-level diagnostic and prognostic information 810 and high-level capability information 812 to the onboard management system 716 for the aircraft. By “high-level” information is meant information sufficient to support a particular decision but that does not necessarily include elements not needed to support the decision. High-level capability information for a given subsystem 712 may be, for example, an indication that the subsystem is functional (or, alternatively, non-functional.) As another example, high-level information may indicate that a particular subsystem 712 is assessed to be capable of functioning for a particular number of future flights. The use of high-level subsystem information can facilitate the incorporation of “health-ready”, supplier-provided subsystems such as pumps, batteries, etc., that are already configured to provide high-level information when installed in an aircraft.

With reference again to FIGS. 10 and 11A-11B, the aircraft management system 716 for an aircraft uses the high-level subsystem diagnostic and prognostic information 810, e.g., from all of the aircraft subsystems 712, in a process 814 to monitor the condition of the aircraft and to obtain high-level aircraft system diagnostic and prognostic information 816. The aircraft management system 716 uses diagnostic and prognostic information 816 from the aircraft subsystems and high-level capability information 812 from the subsystems 712 in a process 818 to assess the capabilities of the aircraft. For example, aircraft capabilities such as range, load, speed, etc. may be determined in the process 818.

High-level aircraft capabilities information 820 and high-level aircraft diagnostic and prognostic information 816 may be used by the aircraft management system 716 to initiate one or more fleet management functions. Based, for example, on conditions and capabilities of a given aircraft, the aircraft management system 716 for that aircraft may, in a process 826, predict one or more service events for the aircraft. Further, in the process 826 the aircraft management system 716 may recommend, for example, a time or time frame for the possible scheduling of a service event.

Additionally or alternatively, an aircraft management system 716 for a given aircraft may use high-level aircraft capabilities 820 and high-level aircraft diagnostic and prognostic information 816 to initiate other or additional fleet management functions. For example, in a process 830 the given aircraft may receive flight scheduling and flight availability request information 832 automatically and/or periodically from the ground fleet management system 710. The aircraft management system may sort and/or otherwise process such flight information to determine, e.g., whether there are scheduled flights available that would be appropriate to the condition and capabilities of the aircraft and for which the aircraft might bid to be designated to fly. For example, where the aircraft management system 716 for a given aircraft has determined that the aircraft is in sufficiently good condition, has fuel and other capabilities sufficient to complete a particular flight to a particular destination, the aircraft may, in a process 832, bid to be scheduled to perform that flight. Other aircraft in the fleet may also bid for flights based on the aircraft conditions and capabilities.

Service predictions, service recommendations, flight scheduling requests and/or other fleet-management-related information may be coordinated in process 834, e.g., by the self-aware aircraft system management functionality 746 for the aircraft and sent to the ground-based fleet management system 710. The aircraft management system 716 may also notify the aircraft pilot and/or flight crew via interfaces 836 as to any or all of the foregoing types of information. In one implementation the fleet management system 710 performs autonomous, optimizing flight allocation and fleet management in process 838. The fleet management system 710 may return approval to a given aircraft 706 for flight(s) bid upon by the aircraft. Additionally or alternatively, the fleet management system 710 may return approval to a given aircraft for scheduling of service event(s) requested by the aircraft.

It should be noted that FIGS. 11A-11B are exemplary and include features that may or may not be included in a given fleet management implementation. For example, implementations are contemplated in which vehicles in a fleet do not bid on trips and/or do not schedule maintenance events. Other or additional fleet management functions could also be performed by a given aircraft in cooperation with a fleet management system.

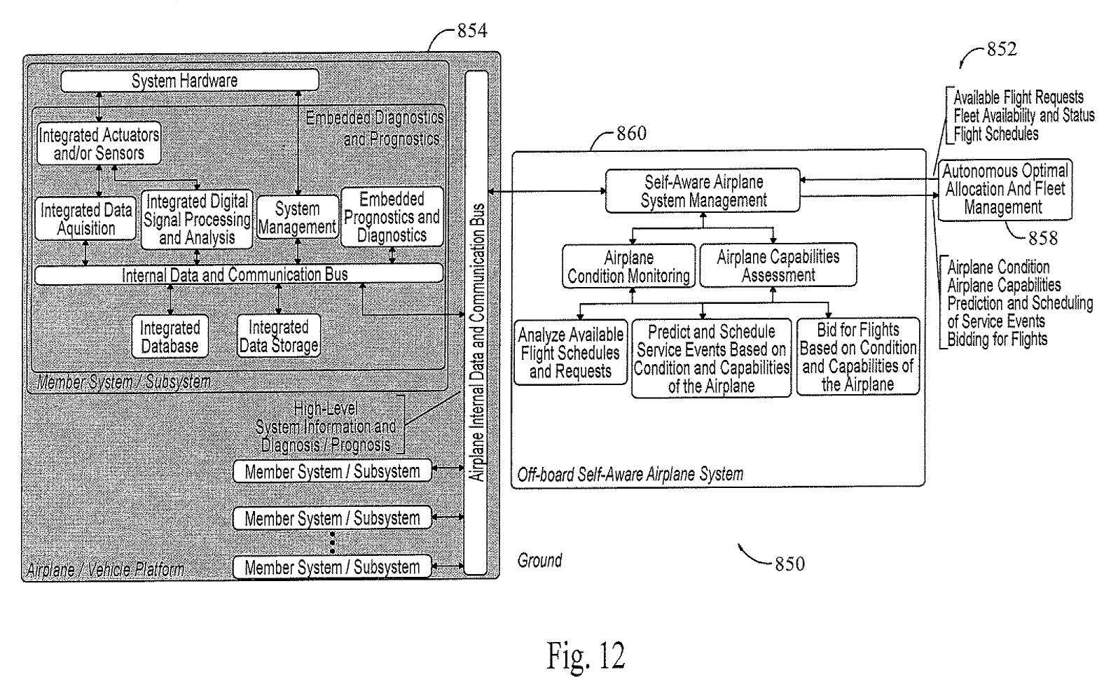

Another implementation of an apparatus for managing a fleet of vehicles, e.g., aircraft, is indicated generally in FIG. 12 by reference number 850. A fleet 852 includes, e.g., a plurality of self-aware aircraft 854, one of which is shown in FIG. 12. Each of a plurality of subsystems 856 of the aircraft is also self-aware, e.g., as previously described with reference to FIG. 10. Each aircraft 854 is configured to communicate with a fleet management system 858, which in the present embodiment is located on the ground. Each aircraft 854 is in communication with an aircraft management system 860 having one or more processors and memory. In the present implementation, the aircraft management system 860 is off-board the aircraft 854 and is located on the ground. It should be noted, however, that in other implementations an off-board aircraft management system may or may not be located on the ground. In various implementations the aircraft management system 860 is modular and may be associated with one or more aircraft 854.

The aircraft management system 860 is configured to monitor conditions and assess capabilities of a given aircraft 854 based on subsystem condition and capability information provided by the aircraft subsystems 856. Based on the monitored conditions and assessed capabilities of an aircraft 854, the aircraft management system 860 may initiate performance of one or more fleet management functions, e.g., as previously described with reference to FIGS. 11A-11B. Thus an aircraft 854 may perform management function(s) in cooperation with the fleet management system 858.

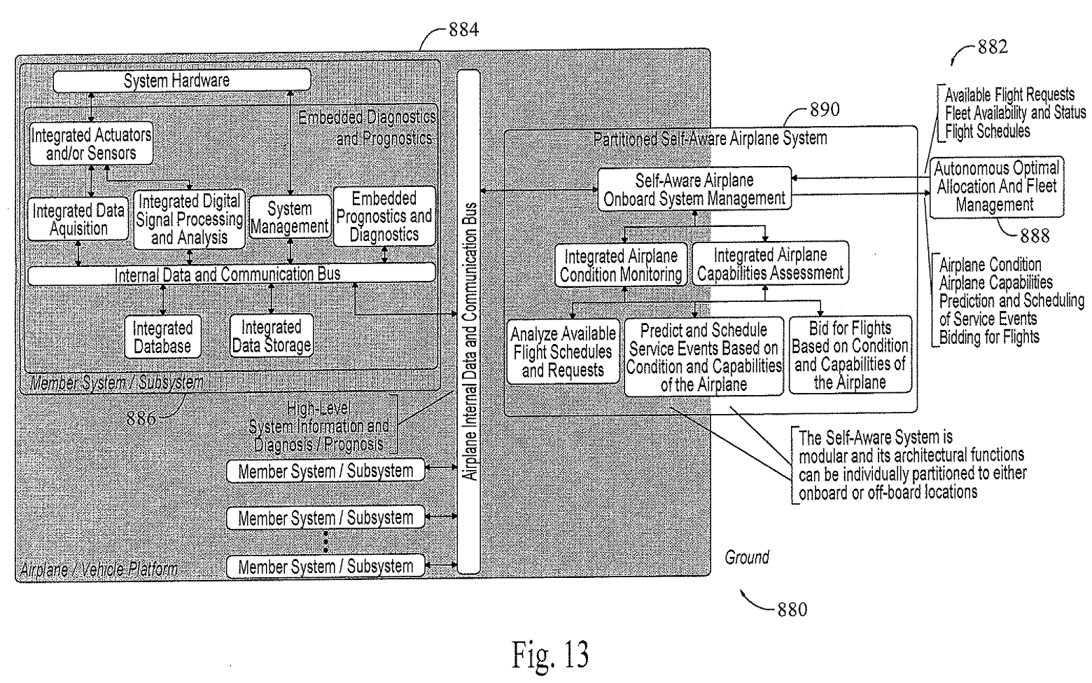

Another implementation of an apparatus for managing a fleet of vehicles, e.g., aircraft, is indicated generally in FIG. 13 by reference number 880. A fleet 882 includes, e.g., a plurality of self-aware aircraft 884, one of which is shown in FIG. 13. Each of a plurality of subsystems 886 of the aircraft is also self-aware, e.g., as previously described with reference to FIG. 10. Each aircraft 884 is configured to communicate with a fleet management system 888, which in the present embodiment is located on the ground. Each aircraft 884 is in communication with an aircraft management system 890 having one or more processors and memory. In the present implementation, the aircraft management system 890 is partly located on the ground and partly on board the aircraft 884. In the present implementation the aircraft management system 890 is modular. The functional components of the aircraft management system 890 are individually partitioned to be either onboard the aircraft or on the ground.

The aircraft management system 890 is configured to monitor conditions and assess capabilities of a given aircraft 884 based on subsystem condition and capability information provided by the aircraft subsystems 886. Based on the monitored conditions and assessed capabilities of an aircraft 884, the aircraft management system 890 may initiate performance of one or more fleet management functions, e.g., as previously described with reference to FIGS. 11A-11B. Thus an aircraft 884 may perform management function(s) in cooperation with the fleet management system 888.

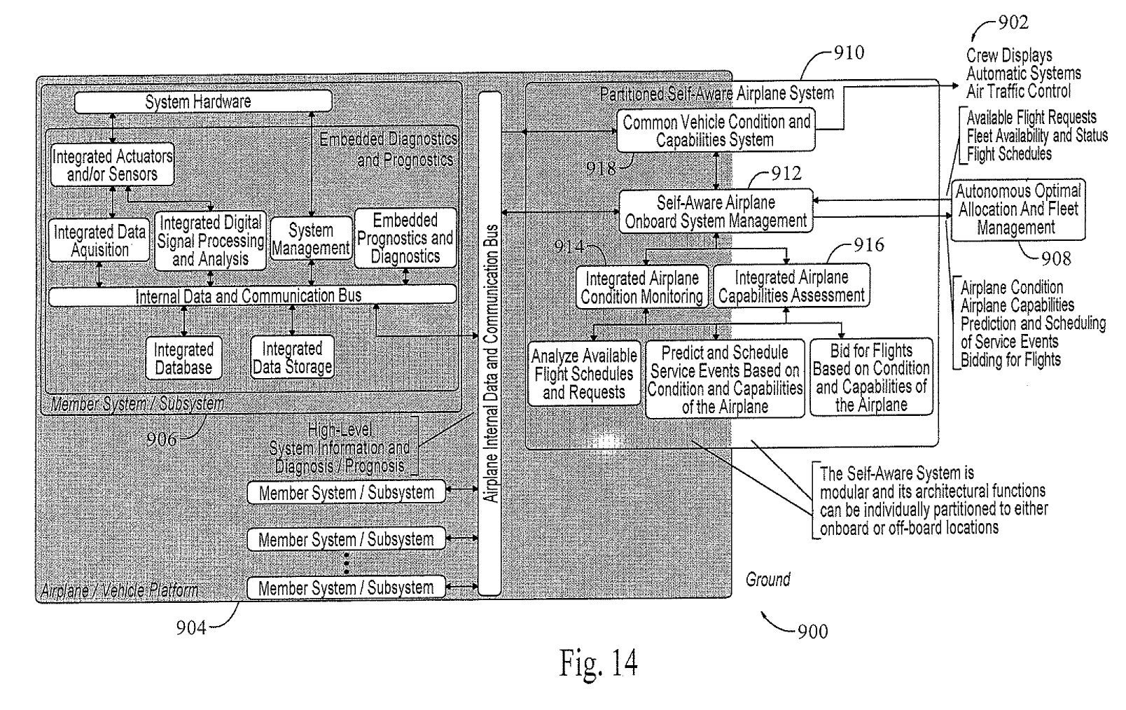

Another implementation of an apparatus for managing a fleet of vehicles, e.g., aircraft, is indicated generally in FIG. 14 by reference number 900. A fleet 902 includes, e.g., a plurality of self-aware aircraft 904, one of which is shown in FIG. 14. Each of a plurality of subsystems 906 of the aircraft is also self-aware, e.g., as previously described with reference to FIG. 10. Each aircraft 904 is configured to communicate with a fleet management system 908, which in the present embodiment is located on the ground. Each aircraft 904 is in communication with an aircraft management system 910 having one or more processors and memory. In the present implementation, the aircraft management system 910 is partly located on the ground and partly on board the aircraft 904. In the present implementation the aircraft management system 910 is modular. The functional components of the aircraft management system 910 are individually partitioned to be either onboard the aircraft or on the ground.

The aircraft management system 910 is configured to monitor conditions and assess capabilities of a given aircraft 904 based on subsystem condition and capability information provided by the aircraft subsystems 906. Integrated into the aircraft management system 910 are a self-aware aircraft system management functionality 912, means for aircraft condition monitoring 914, and means for aircraft capabilities assessment 916. Also provided is a common vehicle condition and capabilities system (CVCCS) 918 including a transponder module, e.g., as previously described with reference to FIG. 1. The CVCCS 918 receives high-level subsystem condition and capability information and is in communication with the self-aware aircraft system management functionality 912. The CVCCS 918 provides aircraft condition and capability information, e.g., to aircraft crew displays, other aircraft systems, and/or to air traffic control systems, e.g., as previously described.

Based on the monitored conditions and assessed capabilities of an aircraft 904, the aircraft management system 910 may initiate performance of one or more fleet management functions, e.g., as previously described with reference to FIGS. 11A-11B. Thus an aircraft 904 may perform management function(s) in cooperation with the fleet management system 908.

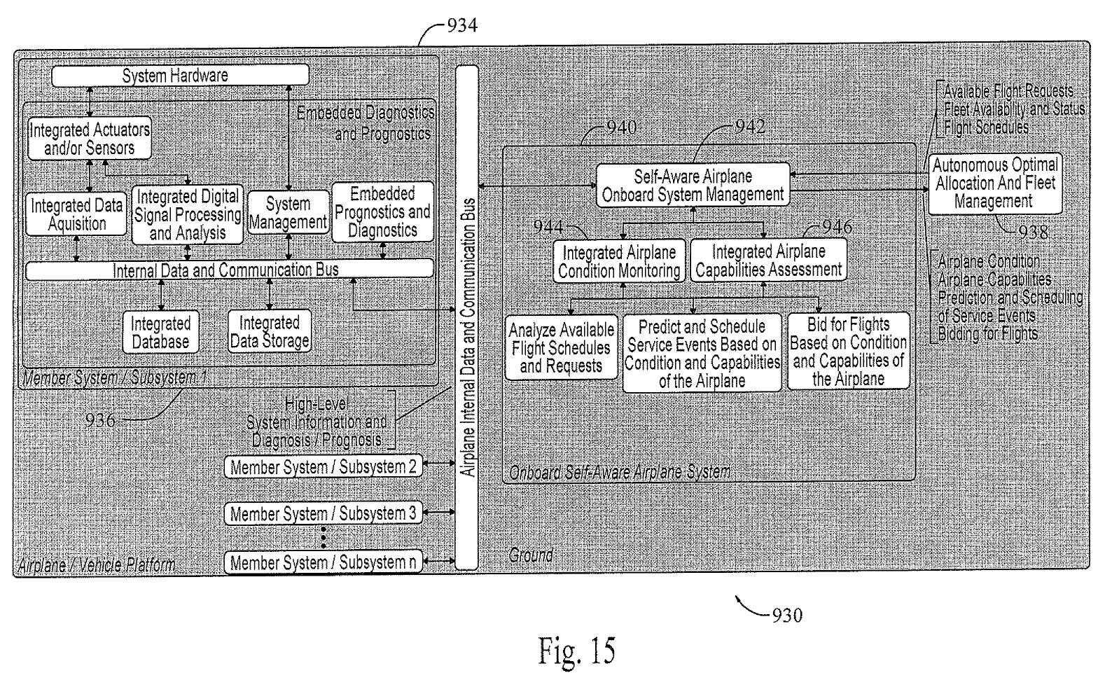

Yet another implementation of an apparatus for managing a fleet of vehicles, e.g., aircraft, is indicated generally in FIG. 15 by reference number 930. The fleet includes, e.g., a plurality of self-aware aircraft 934, one of which is shown in FIG. 15. Each of a plurality of subsystems 936 of the aircraft is also self-aware, e.g., as previously described with reference to FIG. 10. Each aircraft 934 is configured to communicate with a fleet management system 938, which in the present embodiment is located on board the aircraft 934. In the present exemplary configuration, each aircraft 934 is a node on a communication network and may exchange data with other aircraft 934. Autonomous, optimizing flight allocation and fleet management thus can be performed on board the aircraft 934.

Each aircraft 934 is also in communication with an aircraft management system 940 having one or more processors and memory. In the present implementation, the aircraft management system 940 is also on board the aircraft 934. The aircraft management system 940 is configured to monitor conditions and assess capabilities of the aircraft 934 based on subsystem condition and capability information provided by the aircraft subsystems 936. Integrated into the aircraft management system 940 are a self-aware aircraft system management functionality 942, means for aircraft condition monitoring 944, and means for aircraft capabilities assessment 946. Although not shown in FIG. 15, a common vehicle condition and capabilities system (CVCCS) may also be provided in the aircraft management system 940, e.g., as previously described with reference to FIG. 14.

Based on the monitored conditions and assessed capabilities of an aircraft 934, the aircraft management system 940 may initiate performance of one or more fleet management functions, e.g., as previously described with reference to FIGS. 11A-11B. Thus the aircraft 934 may perform management function(s) in cooperation with the fleet management system 938.

Implementations of the foregoing fleet management system may autonomously take into account various criteria for scheduling a given aircraft to fly a given flight and/or to undergo a given maintenance procedure. It can be appreciated that various criteria could be applied automatically to characterize the availability of a given aircraft, e.g., in terms of availability of its subsystems. Since each aircraft is capable of providing real-time information as to its condition and capabilities, the fleet management apparatus can schedule individual aircraft substantially “on the fly” for particular flights and/or for servicing in a timely way. Accordingly, aircraft availability, and flights per aircraft per year, can be increased.

Service event scheduling can be automated, for both routine service and for service to address diagnoses and prognoses by one or more subsystems of an aircraft. Unscheduled interrupts in flight schedules can thereby be substantially reduced or eliminated, and operational and maintenance costs can be significantly reduced. Scheduled interrupts can be automated and optimized, thereby making it possible to integrate aircraft service offerings. Fleet management also can be automated and optimized, thereby reducing fleet management costs.

Various implementations of the disclosure make it possible for a vehicle fleet owner and/or operator to increase the availability of vehicles. For example, for an aircraft fleet, numbers of flights per year can be increased for each aircraft. Maintenance costs can be significantly reduced for a significant improvement in fleet management costs. Additionally, the ability to obtain knowledge as to individual vehicle component conditions and vehicle capabilities make it possible to improve vehicle design as to size, weight, lifetime, and cost.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. Further, it should be understood that unless the context clearly indicates otherwise, the term “based on” when used in the disclosure and/or the claims includes “at least partly based on”, “based at least in part on”, and the like.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. An apparatus for managing a fleet of vehicles, the apparatus comprising:
on each of the vehicles, a plurality of vehicle subsystems, each subsystem capable of monitoring conditions and assessing capabilities of the subsystem; and
for each vehicle, a vehicle management system having one or more processors and memory configured to:
monitor conditions and assess capabilities of the vehicle based on subsystem condition and capability information provided by the subsystems; and
based on the monitored vehicle conditions and assessed vehicle capabilities, initiate performance of one or more fleet management functions.

2. The apparatus of claim 1, further comprising a fleet management system configured to continue performance of fleet management functions initiated by the vehicles.

3. The apparatus of claim 1, wherein to initiate performance of one or more fleet management functions comprises one or more of the following: to predict a service event for the vehicle, to initiate scheduling of a service event for the vehicle, and to bid for a trip by the vehicle.

4. The apparatus of claim 1, wherein at least one of the vehicle subsystems is a plug-in subsystem.

5. The apparatus of claim 1, wherein one or more of the vehicle subsystems are included in a subsystem configured to monitor conditions and assess capabilities of the included subsystems.

6. The apparatus of claim 1, wherein a vehicle management system for a vehicle is configured to provide information to one of the vehicle subsystems from another subsystem of the vehicle.

7. The apparatus of claim 1, the vehicle management system of at least one of the vehicles comprising a transponder module configured to, in real time:
receive sensor input data from a plurality of different sensors of the vehicle via a sensor input interface;
use the sensor input data to determine conditions of a plurality of subsystems of the vehicle; and
based on the determined conditions and on data provided by an integrated vehicle health management (IVHM) system of the vehicle, determine a plurality of performance capabilities of the vehicle;
the vehicle management system further configured to initiate the performance based on the determined vehicle performance capabilities.

8. An automated method of managing a fleet of vehicles, comprising:
in each vehicle, each of a plurality of subsystems of the vehicle monitoring its subsystem condition and assessing its subsystem capabilities based on the monitored subsystem condition;
a vehicle management system for each vehicle monitoring conditions of the vehicle based on condition information from the subsystems and assessing capabilities of the vehicle based on the subsystem conditions and capabilities; and
based on the vehicle condition and capabilities, the vehicle management system for a given one or more of the vehicles performing one or more fleet management functions cooperatively with a fleet management system.

9. The method of claim 8, further comprising the fleet management system continuing performance of one or more fleet management functions initiated by the one or more vehicles.

10. The method of claim 8, further comprising:
one of the vehicle management systems predicting a service event for the corresponding vehicle; and
the fleet management system scheduling the service event.

11. The method of claim 8, further comprising:
one of the vehicle management systems requesting a service event for the corresponding vehicle; and
the fleet management system scheduling the service event.

12. The method of claim 8, further comprising:
one of the vehicle management systems bidding on a trip by the corresponding vehicle; and
the fleet management system scheduling the trip.

13. The method of claim 8, wherein at least one of the subsystems of at least one of the vehicles includes a plug-in subsystem having an embedded functionality for providing subsystem diagnostics and prognostics.

14. A self-aware vehicle comprising:
a plurality of vehicle subsystems, each subsystem capable of monitoring conditions and assessing capabilities of the subsystem; and
a vehicle management system having one or more processors and memory configured to:
monitor conditions and assess capabilities of the vehicle based on subsystem condition and capability information provided by the subsystems; and
based on the monitored vehicle conditions and assessed vehicle capabilities, initiate performance of one or more fleet management functions.

15. The vehicle of claim 14, wherein at least one of the vehicle subsystems is configured to provide a diagnosis of its condition and a prognosis as to its capabilities.

16. The vehicle of claim 14, wherein to initiate performance of one or more fleet management functions comprises one or more of the following: to predict a service event for the vehicle, to initiate scheduling of a service event for the vehicle, and to bid for a trip by the vehicle.

17. The vehicle of claim 14, the vehicle management system configured to receive fleet-related information from a fleet management system for use in performing the one or more fleet management functions.

18. The vehicle of claim 14, wherein at least one of the vehicle subsystems has functionality embedded therein for monitoring conditions and assessing capabilities of the subsystem.

19. The vehicle of claim 14, comprised by a fleet of self-aware vehicles each configured to bid for a trip scheduled by an automated fleet management system.

20. The vehicle of claim 14, comprising an aircraft.
